(19) United States
(12) Patent Application Publication
(10) Pub. No.: US 2024/0306084 A1
(43) Pub. Date: Sep. 12, 2024

(54) NETWORK SELECTION SYSTEM, DEVICE, METHOD AND PROGRAM

(71) Applicant: NIPPON TELEGRAPH AND TELEPHONE CORPORATION, Tokyo (JP)

(72) Inventors: Hiroya ONO, Musashino-shi, Tokyo (JP); Yuki SAKAUE, Musashino-shi, Tokyo (JP); Takuya ABE, Musashino-shi, Tokyo (JP)

(73) Assignee: NIPPON TELEGRAPH AND TELEPHONE CORPORATION, Tokyo (JP)

(21) Appl. No.: 18/276,247

(22) PCT Filed: Feb. 18, 2021
(86) PCT No.: PCT/JP2021/006112

§ 371 Date: Aug. 7, 2023

(51) Int. Cl. H04W 48/18; H04W 64/00

(52) U.S. Cl. CPC H04W 48/18; H04W 64/00

(57) ABSTRACT

An object of the present disclosure is to enable execution of connection destination selection processing by an appropriate optimization engine for each user terminal and enable optimization of a connection destination in a wide range of networks.

There is provided a network selection system having a network selection device that selects a network which is a connection destination of each user terminal, the network selection system including a plurality of network selection devices configured to manage different areas according to position information of a user terminal, in which each network selection device notifies a user terminal present in an area managed by the device itself of an address on a network of the network selection device that manages an area of a movement destination of the user terminal based on the position information notified from the user terminal.

### TECHNICAL FIELD

The present invention relates to an access network selection method.

### BACKGROUND ART

When a user terminal uses a network service, a communication line provided by a communication carrier may be used. Various access means and networks (hereinafter, will be referred to as NW) such as an optical line and a wireless communication line can be used. For example, in the case of an optical line, there are communication standards such as IEEE 802.3 (Ethernet) (Ethernet is a registered trademark) and ITU-T G.983/G.984/G.987/G. 989. In the case of a wireless communication line, there are communication standards such as 3GPP 36Series (LTE, 5G), IEEE 802.11 (wireless LAN), and IEEE 802.16 (WiMAX).

The user terminal can perform communication by selectively using a plurality of communication standards and communication lines. For example, the user terminal can select which one of LTE, wireless LAN, and Bluetooth is used for the smartphone. In addition, it is also possible to selectively use lines of different carriers using the same communication standard by using eSIM or the like (for example, Non Patent Literature 1).

In Non Patent Literature 1, since each access network has different communication qualities such as those of bandwidth and delay, it is possible to improve the quality of the application used by appropriately selectively using the communication qualities according to the application. However, in many cases, appropriate access means is not selected. One of the reasons for this includes a case where the user terminal cannot understand the features of each access network and performs inappropriate NW selection, and interference between the user terminals occurs due to biased access means/NW selection for a plurality of user terminals. As described above, there is a problem that effective use of communication resources in the entire system and improvement of the satisfaction level of the user terminal cannot be achieved even when a plurality of access means is provided.

As a method for solving the problem of Non Patent Literature 1, in a network system in which an overlay NW 82 and the Internet 83 are connected above NWs 81 #1 to 81 #3 connected to a user terminal 92 as illustrated in FIG. 1, a method has been proposed in which an optimization engine present in the overlay NW 82 or the like centrally manages and optimally selects access means used by the user terminal 92 (for example, refer to Non Patent Literature 2 and 3). This method is automatic selection control that does not depend on the user's comprehension level of the NWs 81 #1 to 81 #3, and it is expected that the NWs 81 #1 to 81 #3 connected to the user terminal 92 could be optimized such that conflicts of NW selection among the plurality of user terminals do not occur.

Assuming that the access NW is selected through the present technology, necessary processing is roughly divided into four steps.

First, a step of notifying information necessary for optimization from the user terminal to the optimization engine is performed. Here, the radio wave environment of the peripheral access means viewed from the user terminal, position information of the user terminal itself, and the like are delivered to the optimization engine.

In the next second step, the optimization engine derives an optimum NW to which the user terminal group should connect. Here, the variable optimized by the optimization engine is the connection destination combination of the user terminal group.

In a third step, the optimization engine delivers the optimum connection NW of each user terminal to the user terminal group.

Finally, the user terminal that has received the notification of the optimum connection NW performs switching processing to the corresponding access NW as necessary.

The present technology centrally manages access means of a user terminal group, and in the second step, an optimization engine needs to solve a combination optimization problem. In general, the amount of calculation required to solve the combination optimization problem is enormous. For this reason, it is assumed that a physical area size that can be managed by one optimization engine is limited, and each optimization engine determines a physical area that can be managed.

The user terminal needs to execute the second step with an appropriate optimization engine that manages the area according to the position information. However, a mechanism for selecting an appropriate optimization engine from a plurality of optimization engines having divided management areas and communicating with the selected optimization engine, based on the position information of a user terminal, has not been proposed. In addition, it is desirable that the implementation method can find and switch to the corresponding optimization engine in a short time while suppressing the NW processing and terminal processing load with respect to the movement of the user terminal.

For example, when the user terminal stores all the IP addresses of a large number of optimization engines and attempts to search for a communicating optimization engine on the NW, the user terminal load and the NW load increase. In addition, even when the number of optimization engines is small and the discovery can be quickly performed, communication with a new optimization engine is started again from the first step. Therefore, there is a concern that the time required for optimizing the connection NW becomes longer than that in a case without area movement, which is not efficient handover.

### CITATION LIST

### Non Patent Literature

Non Patent Literature 1: “Implementing eSIM” https://source.android.google.cn/devices/tech/connect/esim-overview
Non Patent Literature 2: Ono, “Study of Optimum User Accommodation Algorithm in Multi-Access Environment Using Bayesian Optimization”, The Institute of Electronics, Information and Communication Engineers General Convention 2020, B6-26, March 2020 https://www.ieice-taikai.jp/2020general/jpn/webpro/html/cs.html
Non Patent Literature 3: I. B. Dhia, “Optimization of Access Points Selection and Resource Allocation in Heterogeneous Wireless Network”, 28 th Annual International Symposium on Personal Indoor Mobile Radio Communications (PIMRC), 2017, Montreal, QC, Canada

### SUMMARY OF INVENTION

### Technical Problem

An object of the present disclosure is to enable execution of connection destination selection processing by an appropriate optimization engine for each user terminal and enable optimization of a connection destination in a wide range of networks.

### Solution to Problem

According to the present disclosure, there are provided a network selection system and a network selection method, including
a plurality of network selection devices configured to manage different areas according to position information of a user terminal in the network selection system having a network selection device that selects a network which is a connection destination of each user terminal, in which
each network selection device notifies a user terminal present in an area managed by the device itself of an address on a network of the network selection device that manages an area of a movement destination of the user terminal based on the position information notified from the user terminal.

According to the present disclosure, there is provided a network selection device that selects a network which is a connection destination of each user terminal, in which
a predetermined area is managed according to position information of a user terminal, and
a user terminal present in an area managed by the device itself is notified of an address on a network of the network selection device that manages an area of a movement destination of the user terminal based on the position information notified from the user terminal.

According to the present disclosure, there is provided a network selection program for causing a computer to function as each function unit included in the network selection device according to the present disclosure, the program being a program for causing a computer to execute each step included in the network selection method executed by the network selection device according to the present disclosure.

### Advantageous Effects of Invention

According to the present disclosure, connection destination selection processing by an appropriate optimization engine can be executed for each user terminal, and connection destinations in a wide range of networks can be optimized.

### BRIEF DESCRIPTION OF DRAWINGS

FIG. 1 illustrates an example of a network configuration of the present disclosure.

FIG. 2 schematically illustrates the present disclosure.

FIG. 3 illustrates an example of functional blocks in the network selection system of the present disclosure.

FIG. 4 is a flowchart illustrating an example of control when a user terminal moves between areas.

FIG. 5 is an explanatory diagram of a method for determining whether or not an optimization engine is within a management area from position information of a user terminal.

FIG. 6 illustrates an example of the management area of the optimization engine.

FIG. 7 is an explanatory diagram in a case where the management areas of the optimization engines overlap each other.

### DESCRIPTION OF EMBODIMENTS

Embodiments of the present disclosure will be described in detail below with reference to the drawings. Note that the present disclosure is not limited to the embodiments described below. These embodiments are merely examples, and the present disclosure can be carried out in forms with various modifications and improvements based on the knowledge of those skilled in the art. Note that components having the same reference numerals in the present specification and the drawings indicate the same components.

### (Points of Present Disclosure)

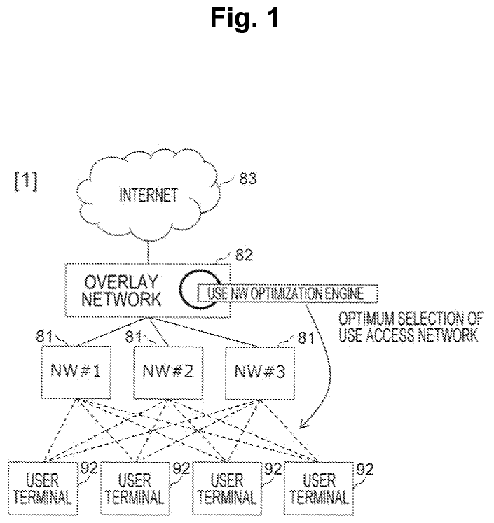

As illustrated in FIG. 1, the network selection system of the present disclosure includes NWs 81 #1 to 81 #3 connectable to a user terminal 92, and an overlay NW 82 is connected above the NWs 81 #1 to 81 #3. The Internet 83 may be connected above the overlay NW 82. An optimization engine 91 is disposed on the overlay NW 82.

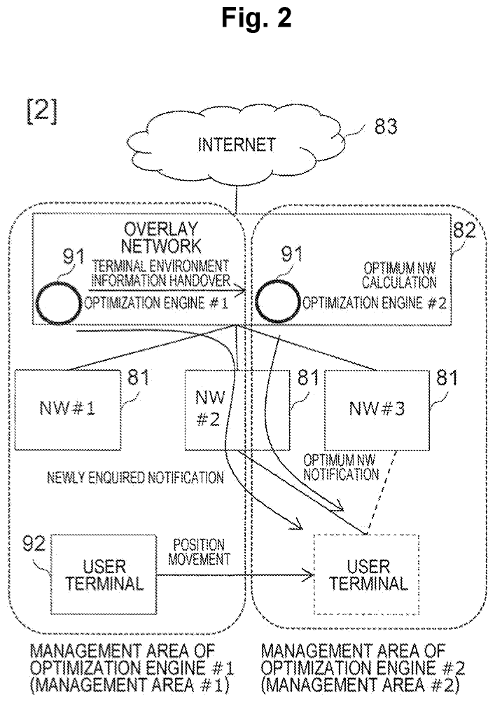

FIG. 2 illustrates an outline of the present disclosure. The network selection system of the present disclosure includes an optimization engine 91 for each area. For example, the user terminal 92 moves from an area #1 managed by the optimization engine 91 #1 to an area #2 managed by the optimization engine 91 #2. As described above, when the connection destination optimization engines 91 are arranged in a distributed manner, the address on the network of the optimization engine 91 #2 that manages the movement destination area is notified along with the position movement of the user terminal 92, and thus the NW selection sequence can be executed with the appropriate optimization engine 91. Specifically, the following method can be exemplified.

The optimization engine 91 holds position coordinates indicating its own management area, and in a case where the position information in the terminal information notified by the user terminal 92 deviates from the management area, the optimization engine 91 that covers the position coordinates of the user terminal 92 is instructed to execute the NW selection sequence.

The optimization engine 91 #1 stores the optimization engine 91 #2 that manages the area #2 adjacent to the area #1, that the optimization engine 91 #1 manages, together with the management area, and determines the new optimization engine 91 #2 with which the user terminal 92 should communicate based on the terminal information notified from the user terminal 92.

At this time, the optimization engine 91 #1 communicated with in the past does not derive the optimum connection NW of the user terminal 92, and notifies the user terminal 92 of only the address of the new optimization engine 91 #2 to be communicated with.

Furthermore, the terminal information already acquired from the user terminal 92 is transferred to the optimization engine 91 #2 that newly exchanges with the user terminal 92, and the optimization engine 91 #2 that has newly received the terminal information derives the optimum NW of the user terminal 92.

In addition, the optimization engine 91 #2 that manages the movement destination area acquires the latest IP address of the user terminal 92 from the optimization engine 91 #1 that manages the movement source, and can immediately notify the user terminal 92 after deriving the optimum connection NW.

### Effects of Present Disclosure

Even when the optimization engines 91 of the connection destination are arranged in a distributed manner, the NW selection sequence is executed without inconsistency, and the change of the optimization engine 91 of the communication destination is realized by lightweight processing without depending on the scale of scale-out of the optimization engine 91. As a result, it is possible to realize dynamic use NW optimization in a wide range, and concomitantly, it is possible to realize improvement in application quality.

In FIG. 2 and the following embodiments, as an example of the present disclosure, an example in which the network selection system includes two optimization engines 91 is shown, but the number of optimization engines 91 may be any number equal to or greater than 2. In the following description, the optimization engines 91 #1 and 91 #2 will be referred to as an optimization engine 91 in a case where it is not necessary to distinguish the optimization engines 91 #1 and 91 #2.

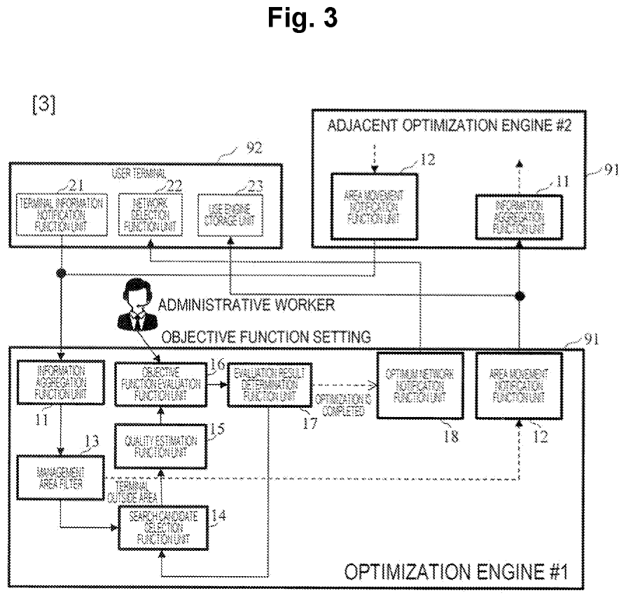

FIG. 3 illustrates an example of functional blocks in the network selection system of the present disclosure.

The user terminal 92 in the present embodiment functions as a communication device of the present disclosure, and includes a terminal information notification function unit 21, a network selection function unit 22, and a use engine storage unit 23. The user terminal 92 can also be realized by a computer and a program, and the program can be recorded in a recording medium or provided through a network.

The terminal information notification function unit 21 notifies the optimization engine 91 of the terminal information. Here, the terminal information is any information that can be used by the optimization engine 91, and includes position information of the user terminal 92. The terminal information may include radio wave environment information with respect to around the user terminal 92, a use application of the user terminal 92, and available access means of the user terminal 92.

The network selection function unit 22 receives an instruction from the optimization engine 91 and switches the network 81 used by the device itself.

The use engine storage unit 23 stores an address on the network of the optimization engine 91 that enquires about the optimum access means. The address on the network is any identification information that can specify the optimization engine 91 on the network, and includes, for example, an IP address or a domain name system (DNS) address.

The optimization engine 91 according to the present embodiment functions as a network selection device of the present disclosure, and includes an information aggregation function unit 11, an area movement notification function unit 12, a management area filter 13, a search candidate selection function unit 14, a quality estimation function unit 15, an objective function evaluation function unit 16, an evaluation result determination function unit 17, and an optimum network notification function unit 18. The optimization engine 91 can also be realized by a computer and a program, and the program can be recorded in a recording medium or provided through a network.

The information aggregation function unit 11 aggregates the terminal information from the terminal information notification function unit 21 of the user terminal 92 and the optimization engine information from the adjacent optimization engine 91. The optimization engine information includes position information of the optimization engine 91, an address on the network, and a management area of the optimization engine 91.

The management area filter 13 stores its own management area, and separates the user terminal 92 in the management area and the user terminal 92 outside the management area from the position information of the user terminal 92.

The area movement notification function unit 12 notifies the user terminal 92 outside its own management area of the change of the optimization engine 91 to the user terminal 92, and hands over the terminal information to the adjacent optimization engine 91.

The search candidate selection function unit 14 extracts a candidate connection pattern from among possible connection patterns of the user terminal 92.

The quality estimation function unit 15 performs quality simulation or estimation for a candidate connection pattern.

The objective function evaluation function unit 16 derives a value of the objective function based on the communication quality or the like of each user terminal 92.

The evaluation result determination function unit 17 determines whether to search for an option again or end the search.

The optimum network notification function unit 18 notifies the user terminal 92 of the derived optimum network 81.

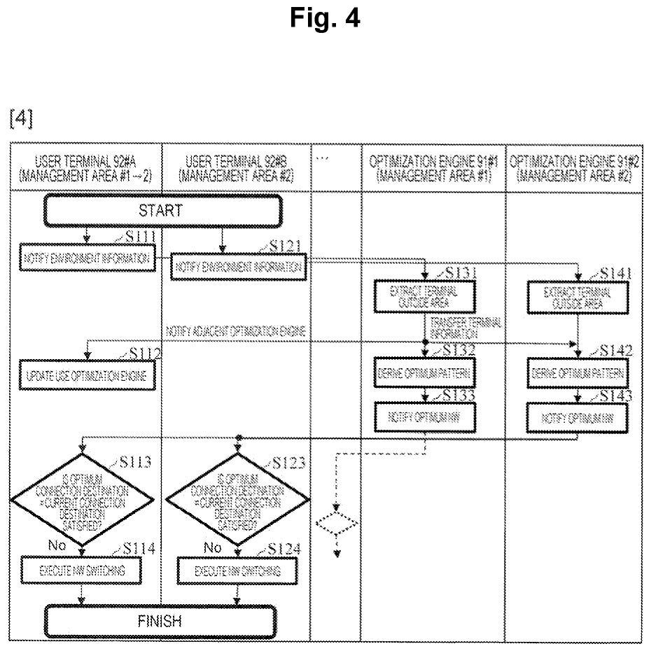

FIG. 4 is a flowchart illustrating an example of control when the user terminal 92 performs the management area movement of the optimization engine. As an example, a situation in which the optimization engine 91 #1 manages the area #1 and the optimization engine 91 #2 manages the area #2 is considered. It is assumed that it is immediately after a user terminal 92A has moved from the area #1 to the area #2, and a user terminal 92B is present in the area #2 similarly to the immediately preceding state, and the control flow in both the areas is illustrated.

The user terminals 92A and 92B respectively notify the optimization engines 91 #1 and 91 #2 to which the user terminals 92A and 92B have enquired about the connection NW immediately before of terminal information such as the position information, the radio wave environment information, the use application information, and the available NW (S111 and S121).

The position information may be two-dimensional information based on latitude and longitude or three-dimensional information including altitude. In addition, a time stamp that has acquired the position information may be added.

The radio wave environment information includes a network name such as a service set identifier (SSID) taking the IEEE 802.11 wireless LAN as an example, and information such as received radio wave strength indicator (RSSI) of a beacon signal in the case of wireless access.

Each of the optimization engines 91 #1 and 91 #2 detects whether or not the user terminal (for example, the user terminal 92A) is present in its own management area (for example, the area #1) based on the position information of the terminal information, and extracts the user terminal 92 that is not present in the management area (S131, S141). In a case where the user terminal 92A is not present in the area #1, the optimization engine 91 #1 transfers the terminal information (for example, information of the user terminal 92A) to the optimization engine (for example, the optimization engine 91 #2) that manages the area including the position information with respect to the user terminal 92A that is not present in the management area, and notifies the user terminal 92A of the address on the network of the optimization engine 91 #2 that manages the movement destination area (for example, the area #2). A method of determining the management area will be described later.

The use engine storage unit 23 of the user terminal 92 that has acquired the address on the network of the new optimization engine 91 stores the acquired address (S112).

At the time of the next control flow, the network to be connected is enquired for the address of the optimization engine 91 that has been newly stored.

Each optimization engine 91 starts execution of the NW selection sequence for the user terminal 92 in its own management area, and derives an optimum NW connection pattern (S132, S142). As a result, a network to be connected to the user terminal 92 is determined.

The optimum pattern derivation is realized by loop processing of the search candidate selection function unit 14, the quality estimation function unit 15, the objective function evaluation function unit 16, and the evaluation result determination function unit 17. Although a specific method is not limited, a specific example will be described.

The search candidate selection function unit 14 can be realized by a mathematical optimization algorithm such as Bayesian optimization.

The quality estimation function unit 15 can be realized by prediction using a mathematical model in which the NW band of the base station, the number of connected devices, and the like are variables, NW simulation, or prediction using a machine learning model.

The objective function evaluation function unit 16 sets an average value of predicted throughput obtained for each user terminal 92, an average value of quality of experience (QoE) of an application derived based on throughput, delay, and the like, and the like. In the optimization engine 91, a connection pattern that maximizes or sufficiently increases the objective function is selected.

The evaluation result determination function unit 17 determines whether or not to end the optimization program by using the allowable time for the optimization execution, the number of optimization loops, and the provisional evaluation value of the objective function being executed as threshold values.

The optimization engine 91 notifies each user terminal 92 in the management area of the optimum connection NW (S133, S143). This function can be realized by a method such as notification using a message format of an Access Network Discovery and Selection Function (ANDSF) standardized in 3GPP.

The user terminal 92 switches the connection NW in response to the notification from the optimization engine 91 (S113, S114, S123, S124). As a result, the execution of the NW selection sequence is completed. An existing smartphone or the like can be realized because there are a function of switching between a 3GPP line and a wireless LAN line and a development API for realizing the function.

In the NW selection sequence, any optimization engine 91 and user terminal 92 related to switching of the NW execute steps. For example, in a case where the optimization engine 91 #1 notifies the user terminal 92 #A of the switching of the connection NW, in the NW selection sequence, the optimization engine 91 #1 executes steps S132 and S133, and the user terminal 92 #A executes steps S113 and S114.

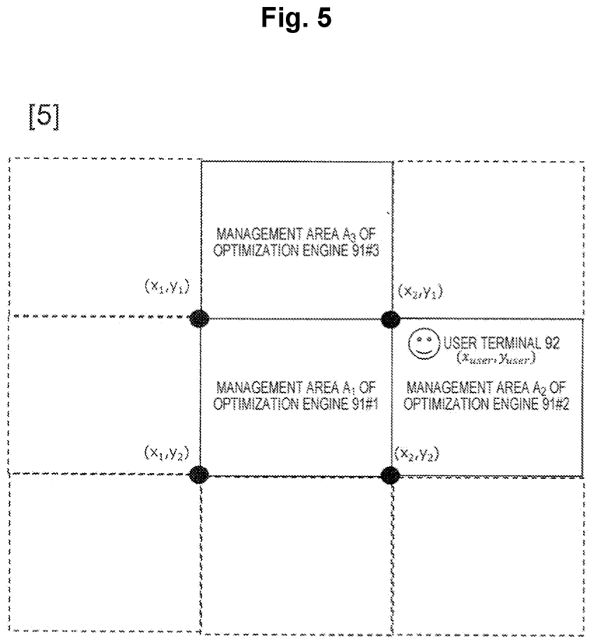

With reference to FIG. 5, a specific example will be described of a method of determining whether or not the optimization engine 91 is within the management area from the position information of the user terminal 92. A situation in which the management area of the optimization engine 91 is divided by a quadrangle in two-dimensional coordinates is considered. A management area A₁ of the optimization engine 91 #1 is

$${A}_{1} = \{ ( x , y ) s . t . {x}_{1} \leq x \leq {x}_{2} and {y}_{1} \leq y \leq {y}_{2} \} \qquad [ Math . 1 ]$$

Therefore, whether or not the user terminal 92 is in the management area can be determined by

$${x}_{1} \leq {x}_{user} \leq {x}_{2} and {y}_{1} \leq {y}_{user} \leq {y}_{2} \qquad [ Math . 2 ]$$

when the coordinates of the user terminal 92 is (xᵤₛₑᵣ, yᵤₛₑᵣ).

The optimization engine 91 stores x and y coordinates (x₁, x₂, y₁, y₂) of an end point of its own management area, and stores network addresses related to the optimization engines 91 of adjacent areas in both positive and negative directions of the x and y axes.

The number of elements of the array to be stored is at most eight when considered by the number of adjacent areas. Furthermore, in a case where the cover area of the single optimization engine 91 is small with respect to the moving speed of the user terminal 92, and movement across a plurality of areas can occur in a short time, the optimization engine information such as the position information and the IP address of the optimization engine 91 separated from its own management area by 2 areas or more may be stored and used for notification to the user terminal 92. When the IP address and the management area of the optimization engine 91 separated by n areas in the periphery are stored, it is necessary to store optimization engine information of (2n+1)²−1 optimization engines 91.

In a case where the moving distance of the user terminal 92 is extremely large and the position information deviates from the surrounding area stored in the optimization engine 91, the optimization engine 91 that manages the area in the direction in which the user terminal 92 is present is set as an optimization engine 91 that provisionally manages the area, and the provisional optimization engine 91 sets the provisional optimization engine 91 that manages the area in the direction in which the user terminal 92 is present as a new provisional optimization engine 91. By hopping between the management areas in this manner, even in a case where the position information of the user terminal 92 is suddenly changed, the optimization engine 91 suitable for the position information of the user terminal 92 is finally notified.

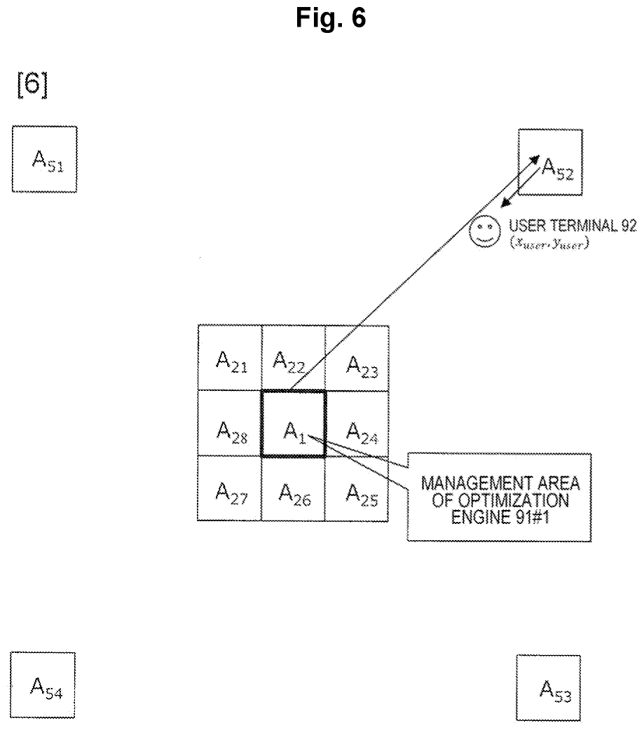

In addition, the IP address and the position information of the other optimization engine 91 stored by the optimization engine 91 may not necessarily have to belong to the adjacent area. For example, as illustrated in FIG. 6, the optimization engine 91 #1 may store optimization engine information that manages the eight adjacent areas A₂₁ to A₂₈, and may store information of the optimization engine 91 that manages the areas A₅₁ to A₅₄ that are significantly distant from each other. With such an arrangement, it is possible to suppress the number of handovers necessary for the position of the user terminal 92 and the management optimization engine 91 to be engaged.

In a case where each optimization engine 91 holds only optimization engine information of eight adjacent areas, it is necessary to perform handover three times from the area A₁ managed by the optimization engine 91 #1 in FIG. 6 until communication between the user terminal 92 and the optimization engine 91 of the corresponding area is realized. On the other hand, in a case where the optimization engine 91 #1 holds the optimization engine information of the areas A₅₁ to A₅₄ away from the area A₁, it can be realized by two handovers using the handover to the optimization engine 91 close to the user terminal 92. For example, in a case where the power of the user terminal 92 is turned off for a long time, and a significant position movement is performed during that time, the area when the power is turned on may greatly deviate from the management area of the optimization engine 91 in the past, and in such a situation, the user terminal 92 and the optimization engine 91 can be engaged in a short time. In addition, the present method can also be applied to a case where communication becomes possible after a state where communication cannot be performed for a long time continues as in the onboard mode.

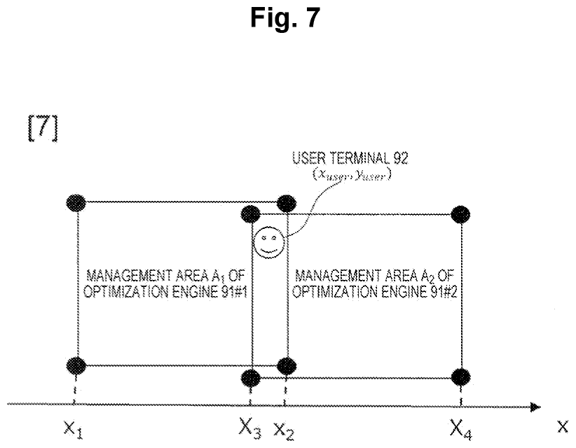

Next, an example in which the management areas of the optimization engine 91 overlap each other will be described with reference to FIG. 7. In this case, the coordinates (x₁ and x₂ in FIG. 7) of the end point of the management area A₁ of its own are stored, and the coordinates (x₃ and x₄ in FIG. 7) of the end point of the adjacent management area A are stored. The same applies to the Y coordinate.

In a case where it is found that the user terminal 92 is present at the overlapping part of the plurality of management areas, a method of selecting the optimization engine 91 belonged to based on the moving speed information of the user terminal 92, which is included in the terminal information, may be conceived. For example, past position information of the user terminal 92 is stored, and in a case where a position change in the past and the current x direction is a positive direction, handover processing is performed so as to belong to the optimization engine 91 #2.

### INDUSTRIAL APPLICABILITY

The present disclosure can be applied to information communication industry.

### REFERENCE SIGNS LIST

11 Information aggregation function unit
12 Area movement notification function unit
13 Management area filter
14 Search candidate selection function unit
15 Quality estimation function unit
16 Objective function evaluation function unit
17 Evaluation result determination function unit
18 Optimum network notification function unit
21 Terminal information notification function unit
22 Network selection function unit
23 Use engine storage unit
81 Network
82 Overlay network
83 Internet
91 Optimization engine
92 User terminal

1. A network selection system having a network selection device that selects a network which is a connection destination of each user terminal, the network selection system comprising
a plurality of network selection devices configured to manage different areas according to position information of a user terminal, wherein
each network selection device notifies a user terminal present in an area managed by the device itself of an address on a network of the network selection device that manages an area of a movement destination of the user terminal based on the position information notified from the user terminal.

2. The network selection system according to claim 1, wherein
each network selection device transfers terminal information of the corresponding user terminal to the network selection device that manages the area of the movement destination of the user terminal, and
the network selection device that manages the area of the movement destination of the user terminal determines a network to be connected to the user terminal in the area managed by the device itself by using the acquired terminal information of the user terminal.

3. A network selection method wherein
in a network selection system having a network selection device that selects a network which is a connection destination of each user terminal, the network selection system includes a plurality of network selection devices configured to manage different areas according to position information of a user terminal, and
each network selection device notifies a user terminal present in an area managed by the device itself of an address on a network of the network selection device that manages an area of a movement destination of the user terminal based on the position information notified from the user terminal.

4. A network selection device that selects a network which is a connection destination of a user terminal, wherein
a predetermined area is managed according to position information of a user terminal, and
a user terminal present in an area managed by the device itself is notified of an address on a network of the network selection device that manages an area of a movement destination of the user terminal based on the position information notified from the user terminal.

5. A non-transitory computer-readable medium having computer-executable instructions that, upon execution of the instructions by a processor of a computer, cause the computer to function as the network selection device according to claim 4.
